(19) United States
(12) Patent Application Publication
(10) Pub. No.: US 2023/0410087 A1
(43) Pub. Date: Dec. 21, 2023

(54) SYSTEM AND METHOD OF OPERATING A SECURE CONTACTLESS TRANSACTION

(71) Applicant: Apple Inc., Cupertino, CA (US)

(72) Inventors: Eran Hollander, Needham, MA (US); Damien Balsan, Belmont, MA (US); Olivier M. Martin de la Bastide, Paris (FR); Sebastien Fontaine, Montreal (CA); Frank Andries van den Berg, San Jose, CA (US)

(21) Appl. No.: 18/365,155

(22) Filed: Aug. 3, 2023

Related U.S. Application Data
(63) Continuation of application No. 17/503,125, filed on Oct. 15, 2021.
Application No. 17/503,125 is a continuation of application No. PCT/IB2020/054049, filed on Apr. 29, 2020.
(60) Provisional application No. 62/901,623, filed on Sep. 17, 2019.
(60) Provisional application No. 62/874,224, filed on Jul. 15, 2019.
(60) Provisional application No. 62/841,030, filed on Apr. 30, 2019.
(60) Provisional application No. 62/840,376, filed on Apr. 29, 2019.

(51) Int. Cl. G06Q 20/32; G06Q 20/38; G06Q 20/40

(52) U.S. Cl. CPC G06Q 20/3278; G06Q 20/401; G06Q 20/3825; G06Q 20/3821

(57) ABSTRACT

There is disclosed a method and system for authorizing payment for a transaction between a buyer and a seller. A payment request may be received from a device associated with the seller. An authentication request comprising transaction information may be transmitted to an authentication service. An indication that the buyer has been authenticated may be received from the authentication service. A transaction request may be transmitted after the buyer has been authenticated.

### CROSS-REFERENCES TO RELATED APPLICATIONS

This present application is a continuation application of U.S. patent application Ser. No. 17/503,125, filed on Oct. 15, 2021, entitled “SYSTEM AND METHOD OF OPERATING A SECURE CONTACTLESS TRANSACTION,” which is a continuation of PCT application No. PCT/M2020/054049, filed on Apr. 29, 2020, entitled “SYSTEM AND METHOD OF OPERATING A SECURE CONTACTLESS TRANSACTION,” which claims the benefit of and priority to U.S. Provisional Patent Application No. 62/901,623, filed on Sep. 17, 2019, entitled “SYSTEM AND METHOD OF OPERATING A SECURE CONTACTLESS TRANSACTION,” U.S. Provisional Patent Application No. 62/874,224, filed on Jul. 15, 2019, entitled “SYSTEM AND METHOD OF OPERATING A SECURE CONTACTLESS TRANSACTION,” U.S. Provisional Patent Application No. 62/841,030, filed on Apr. 30, 2019, entitled “SYSTEM AND METHOD OF OPERATING A SECURED TRANSACTION,” and U.S. Provisional Patent Application No. 62/840,376, filed on Apr. 29, 2019, entitled “SYSTEM AND METHOD OF OPERATING A SECURE CONTACTLESS TRANSACTION.” Each patent and application mentioned in this paragraph is incorporated by reference herein in its entirety.

### FIELD OF THE INVENTION

The present technology relates to systems and methods of operating a secure contactless transactions.

### BACKGROUND OF THE INVENTION

Payment services, such as credit card transactions or payments made using mobile devices, are frequently subject to fraudulent transactions. These fraudulent transactions can be quite costly to issuers, sellers, customers, etc. In order to reduce the amount of fraudulent transactions, various authentication measures have been developed. These authentication measures can bet cumbersome for buyers and sellers.

### BRIEF SUMMARY OF THE INVENTION

Various measures may be used to authenticate a transaction. The authentication process may require little to no additional input from the buyer and/or seller. The payment account of a buyer may be associated with a mobile device of the buyer. After a buyer attempts to make a payment, a message may be sent to the buyer's mobile device requesting that the buyer verify that they wish to authorize the transaction. The location of the buyer's device may be determined and compared to the location of the seller. If the buyer's device is near the seller, the transaction may be authorized. A signature of the buyer's device may be determined and stored. If the signature of the buyer's device is detected by the seller's device, the transaction may be authorized.

According to a first broad aspect of the present technology, there is provided a method for authorizing payment for a transaction between a buyer and a seller. The method comprises: receiving a payment request from a device associated with the seller; transmitting, to an authentication service, an authentication request comprising transaction information; receiving, from the authentication service, an indication that the buyer has been authenticated; and after the buyer has been authenticated, transmitting a transaction request to complete the transaction.

In some implementations of the method, the method further comprises transmitting, by the authentication service, and to the device associated with the buyer, a request to authorize the transaction through an application on the device associated with the buyer.

In some implementations of the method, the method further comprises determining, by the authentication service, an identifier corresponding to the device associated with the buyer.

In some implementations of the method, the authentication request comprises information corresponding to the device associated with the seller.

In some implementations of the method, the authentication request comprises a token from a mobile wallet.

In some implementations of the method, the transaction request comprises the token from the mobile wallet.

In some implementations of the method, the authentication request comprises a payment card number.

In some implementations of the method, the transaction request comprises the payment card number.

In some implementations of the method, the authentication request comprises an amount of the transaction.

In some implementations of the method, the transaction request comprises the amount of the transaction.

In some implementations of the method, the authentication request comprises information indicating the seller.

In some implementations of the method, the transaction request comprises the information indicating the seller.

In some implementations of the method, the indication that the buyer has been authenticated comprises a token.

In some implementations of the method, the transaction request comprises the token.

According to another broad aspect of the present technology, there is provided a method for authorizing payment for a transaction between a buyer and a seller. The method comprises: receiving a payment request from a device associated with the seller; transmitting, to an authentication service, an authentication request comprising transaction information; receiving, from the authentication service, an indication that the buyer has failed authentication; and after receiving the indication that the buyer has failed authentication, transmitting a transaction request to complete the transaction.

In some implementations of the method, the method further comprises determining, by the authentication service, that the device associated with the seller has failed authentication.

In some implementations of the method, the method further comprises transmitting, by the authentication service, and to the device associated with the buyer, a one-time password to be entered for authentication.

In some implementations of the method, the method further comprises transmitting, by the authentication service, and to the device associated with the buyer, a request to authorize the transaction through an application on the device associated with the buyer.

In some implementations of the method, the method further comprises determining, by the authentication service, an identifier corresponding to the device associated with the buyer.

In some implementations of the method, the authentication request comprises information corresponding to the device associated with the seller.

In some implementations of the method, the authentication request comprises a token from a mobile wallet.

In some implementations of the method, the authentication request comprises a payment card number.

In some implementations of the method, the authentication request comprises an amount of the transaction.

In some implementations of the method, the authentication request comprises information indicating the seller.

Various implementations of the present technology provide a non-transitory computer-readable medium storing program instructions for executing one or more methods described herein, the program instructions being executable by a processor of a computer-based system.

Various implementations of the present technology provide a computer-based system, such as, for example, but without being limitative, an electronic device comprising at least one processor and a memory storing program instructions for executing one or more methods described herein, the program instructions being executable by the at least one processor of the electronic device.

Additional and/or alternative features, aspects and advantages of implementations of the present technology will become apparent from the following description, the accompanying drawings, and the appended claims.

### BRIEF DESCRIPTION OF THE DRAWINGS

These and other features, aspects and advantages of the present technology will become better understood with regard to the following description, appended claims and accompanying drawings where:

FIG. 1 is an illustration of an exemplary environment for executing a secure contactless transaction in accordance with embodiments of the present technology;

FIG. 2 is an illustration of a high-level architecture of certain components of the environment shown in FIG. 1;

FIGS. 3 and 4 are flowchart representations of communication flows between several entities for conducting a secure contactless transaction in accordance with embodiments of the present technology;

FIG. 5 is an illustration of a method carried out in accordance with non-limiting embodiments of the present technology;

FIG. 6 is a flowchart representation of communication flows between several entities for conducting a secure contactless transaction according to a first alternative embodiment;

FIG. 7 is an illustration of a first alternative method carried out in accordance with non-limiting embodiments of the present technology;

FIG. 8 is a flowchart representation of communication flows between several entities for conducting a secure contactless transaction according to a second alternative embodiment;

FIG. 9 is an illustration of a second alternative method carried out in accordance with non-limiting embodiments of the present technology;

FIGS. 10 to 15 illustrate exemplary embodiments of graphical user interfaces (GUIs) implementing the present technology;

FIG. 16 is a flowchart representation of a method for conducting a transaction in accordance with non-limiting embodiments of the present technology; and

FIG. 17 is a flowchart representation of communication flows between several entities for conducting a transaction in accordance with embodiments of the present technology.

### DETAILED DESCRIPTION OF THE DRAWINGS

Various exemplary embodiments of the described technology will be described more fully hereinafter with reference to the accompanying drawings, in which exemplary embodiments are shown. The present inventive concept may, however, be embodied in many different forms and should not be construed as limited to the exemplary embodiments set forth herein. Rather, these exemplary embodiments are provided so that the disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular exemplary embodiments and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the present disclosure, reference is made to secure transactions (for example, but without being limitative, contact and contactless transactions), secure elements (for example, but without being limitative, chipset, secured chipset, hardware embedding secured component, software embedding secured component, or firmware embedding secured component) and security standards. Examples of security standards include, without being limitative, certification standards from Europay, MasterCard, and Visa (EMV), EMVCo, MasterCard®, Visa®, American Express®, JCB®, Discover® and from the PCI SSC (Payment Card Industry Security Standards Council), founded by MasterCard®, Visa®, American Express®, Discover® and JCB® and dealing specifically with the definition of security standards for financial transactions. Reference to secure transactions, secure elements, and security standards is made for the purpose of illustration and is intended to be exemplary of the present technology and not limiting of the scope thereof.

In the context of the present technology, a “processor” may refer to a system on chip (SoC), an integrated circuit that integrates components of a computer in a single chip. A typical SoC may include but is not limited to one or more general-purpose microprocessors or Central Processing Units (CPUs), co-processors such as a digital signal processor (DSP), a Graphics Processing Unit (GPU), and multimedia coprocessors such as MEG and JPEG encoders and decoders. The SoC may also include modems for various wireless communications interfaces including cellular (e.g. LTE/4G, 3G, GSM, CDMA, etc.), Bluetooth, and Wireless Fidelity (Wi-Fi) (IEEE 802.11). The SoC may include memory controllers for interfacing with on-die or external DRAM memory chips, and on-die memory blocks including a selection of ROM, SRAM, DRAM, EEPROM and flash memory. The SoC may additionally include timing sources, peripherals including counter-timers, real-time timers and power-on reset generators, debug, JTAG and Design For Test (DFT) interfaces, external interfaces, analog interfaces, voltage regulators, power management circuits, etc. The SoC may also include connectivity components such as simple buses or on-chip networks following the ARM Advanced Microcontroller Bus Architecture (AMBA) specification connecting these blocks together as known in the art. Some blocks may be packaged separately and stacked on the top of the SoC, a design known in the art as Package-on-package (PoP). Alternatively some blocks may be comprised in distinct integrated circuits (or dies) but packaged together, a design known in the art as a System in Package (SiP).

In the context of the present technology, an “isolated secured area of the processor (ISA)” may refer to a processing entity characterized by specific hardware and/or software components subject to a certification ensuring a specific level of security according to specific security standards. The isolated secured area ensures that sensitive data is stored, processed and protected in a secured and trusted environment of the processor while maintaining high processing speeds and large amounts of accessible memory. The isolated secured area may offer isolated execution, secure storage, remote attestation, secure provisioning, trusted boot and trusted path. The isolated secured area allows the processor to operate in two logical modes: normal world or secure world. The normal world is run by the non-secure area of the processor and may comprise the non-secure Rich Operating System (Rich OS) and the software components and applications that run on top of the Rich OS. The normal world is excluded from accessing resources that are provisioned for exclusive use in the secure world. The secure world is run by the isolated secured area, which is the only entity to have access to resources provisioned for use exclusively in the secured area, such as certain delineated ranges of ROM or RAM memory, processor or co-processor configuration registers, and certain peripherals such as display controllers or touch screen controllers, and their associated configuration registers. Some of the resources provisioned for the exclusive use of the isolated secure area may be on the same die or package as the SoC, while others may be contained in a different die or package. Some of the resources may be dynamically provisioned for the exclusive use of the isolated secure area at certain times, while at other times they may be available for use by the normal world. The isolated secured area only runs authorized and trusted applications and provides security against logical attacks generated in the Rich OS environment, attacks aiming to compromise boot firmware, attacks that exploit debug and test interfaces and other non-invasive attacks. Non-limiting examples of an isolated secured area of the processor include Trusted Execution Environment (TEE), Intel Trusted Execution Technology (TXT), the Trusted Platform Module (TPM), the Hengzhi chip and the IBM Embedded Security Subsystem (ESS) chip. In some embodiments, the isolated secured area of the processor is designed so as to not be accessed, even by a human administrator. In some embodiments, the isolated secured area may be implemented partially or completely via a dedicated hardware element such as, but without being limited thereto, a secure element as defined in the paragraph below. Other variations of the isolated secured area may also be envisioned by the person skilled in the art of the present technology without departing from the scope of the present technology.

In the context of the present technology, a “secure element” may refer to a processing entity characterized by specific hardware and/or software components which may be subject to a certification ensuring a specific level of security according to specific security standards. From a hardware perspective, a secure element includes the usual components found in a computing entity: at least one microprocessor (e.g. CPU), memory (e.g. ROM, RAM or FLASH memory), communication interfaces, etc. Specific hardware components may also be included to implement specific functionalities particular to a secure element. For instance, a cryptographic accelerator may be included. Also, various tamper resistance, tamper detection and/or tamper response features may be included to prevent a malicious person from extracting sensitive information from the secure element. Anti-tamper measures may comprise hardware aspects, software aspects, or a combination of hardware and software. Also, certain counter-measures to prevent side-channel attacks aiming to recover cryptographic keys or other sensitive information may be included in the secure element. Counter-measures against side-channel attacks may include hardware aspects, software aspects, or both. Also, measures to reduce EM emissions, such as shielding, may be included, to protect the secure element from eavesdropping. In the context of financial transactions, the certification of the secure element ensures that various financial entities are willing to use the secure element to store and process critical financial data, and to perform secured financial transactions using the critical financial data. In some embodiments, the secure element may be solely characterized by software components. The secure element may be, in some embodiments, implemented partially or completely as an isolated secured area of the processor, such as the isolated secured as described in the paragraph above, in which case, the secure element may be implemented, for example, but without being limitative, as a TEE, a TPM and/or a ESS. In some embodiments, the secure element (SE) may also be equally referred to as an embedded secure element (eSE). Other variations of the secure element may also be envisioned by the person skilled in the art of the present technology without departing from the scope of the present technology.

Even though the various components defined above are each associated with a definition, it should be understood that each one of the various components should not be construed as being solely limited to the specific functions and/or specifics provided in the associated definition. To the contrary, other functions and/or specifics may be added, removed or combined without departing from the scope of the present technology.

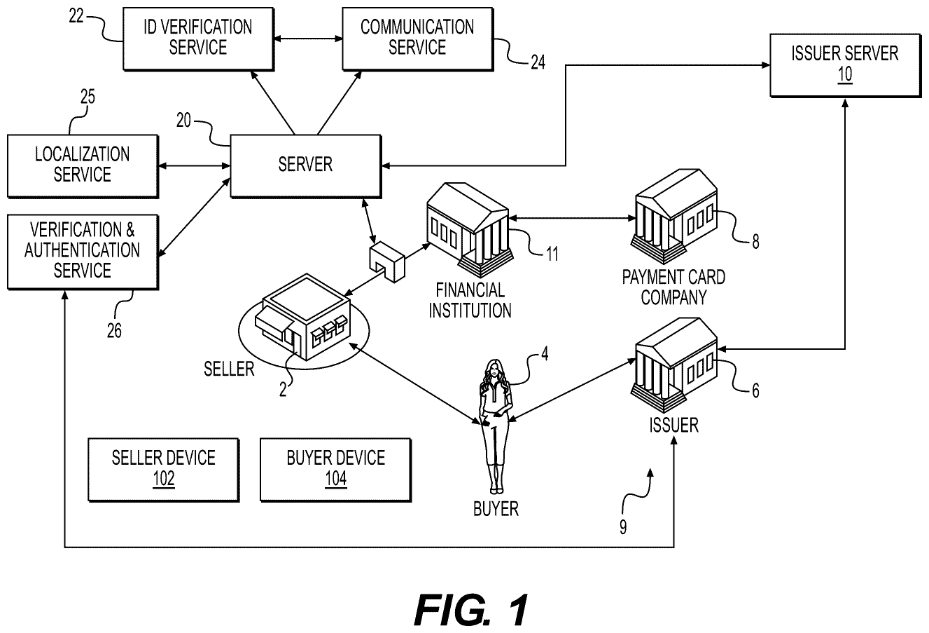

FIG. 1 illustrates a diagrammatical representation of an environment 9 for conducting a secured financial transaction from a first device 102 (e.g., a seller device 102 in the illustrated example, which may also be referred to as a merchant device) while leveraging a second device 104 (e.g., a buyer device 104) to execute an authenticating step in accordance with embodiments of the present technology. In the illustrated embodiment, the seller device 102 is associated with a seller 2 (i.e. merchant) and the buyer device 104 is associated with a buyer 4 (i.e. customer). In this example, the buyer 4 is in a contractual relationship with an issuer 6, equally referred to as a financial institution holding a buyer's financial account. The issuer 6 may be a bank that maintains the customer's checking account and/or credit card account. In some embodiments, the issuer 6 may also be an organization operating prepaid cards, debit cards and/or omnibus accounts that belong to a third party and the buyer has a card under that account. The issuer 6 may provide the buyer 4 with a token to provide authentication during financial transactions. Such a token may be, for example, a payment card and/or a secured unique identification component which may be embedded in the buyer device 104 (e.g. as a virtualized payment card which may be stored in a mobile wallet), including but not limited to, a quick response (QR) code, a barcode, an alphanumeric code, an audible sound, an image, a NFC or Bluetooth communication, or any other audio/visual/digital ‘token’ which may be communicated between seller devices 102 and buyer devices 104. In some embodiments, the token may also contain any bio information about the buyer 4 such as a finger print, a voice signature, an image identifier (ID), a retinal scan, an application on the device, code, etc.

The payment card is provided by a payment card company 8 and may be, for example but without being limitative, a debit card from a regional payment scheme (such as the company Interac® or China Union Pay®) or a credit card from one of the credit card companies such as MasterCard®, Visa®, American Express®, JCB®, and Discover®. Other examples of a payment card may be envisioned without departing from the scope of the present technology. The payment card may contain and/or provide data related to the buyer's financial account through a magnetic strip, a smart card chip and/or through a tag having radio frequency identification (RFID) circuitry. The tag including RFID circuitry may provide contactless transaction capabilities, in particular contactless transaction capabilities compliant with Europay, MasterCard, and Visa (EMV) security standards (e.g. Visa Paywave®, MasterCard PayPass®, American Express ExpressPay®, Interac Flash®, Discover Zip®). The data related to the buyer's financial account may be any kind of data that allows a financial account to be identified during a transaction. For example, but without being limitative, such data may include keys, certificates, and payment card numbers. In some embodiments, the payment card numbers may be embodied as a primary account number (PAN). In some embodiments, the payment card company 8 stores data relating to the individual to which the payment card is issued, such as the buyer 4. Such information may include a cardholder name, an address associated with the individual, and/or information relating to a mobile wallet of the individual.

In the illustrated embodiment, the seller 2 is in a contractual relationship with a financial institution 11 holding a seller's financial account. The financial institution 11 may be a bank that maintains the seller's checking account and/or credit, debit, or prepaid card account which may interact with the payment card company 8. The financial institution 11 allows the seller 2 to conduct financial transactions, through a server 20. The server 20 may be configured to manage payment terminals and/or conduct transactions for payment acceptance by the seller 2. For example the server 20 may be based on the Hive™ platform from Mobeewave, or any other suitable platform.

In accordance with embodiments of the present technology, the server 20 may interact with an identification (ID) verification service 22, a communication service 24, a localization service 25 and a verification & authentication service 26. In some embodiments, the communication service 24 may implement a short message service (SMS service). As an example, but without being limitative, the ID verification service 22 may be embodied as the PayFone™ or Whitepages Pro™ API. The ID verification service 22 may allow retrieving a name and/or an address associated with a phone number or a phone ID. As an example, the communication service 24 may allow automatic sending of SMS messages, such as to the seller device 102 and/or buyer device 104. As an example, but without being limitative, the communication service 24 may be embodied as the Twilio™ SMS API.

The localization service 25 may determine a location of the seller device 102 and/or a location of the buyer device 104. These locations may be obtained in multiple ways, for example, by requesting positions directly from the devices 102 or 104 which may operate self-location services. Positions of the seller device 102 and/or the buyer device 104 may also be established indirectly, for example by querying operators associated with the devices 102 or by querying other phone number based position services like PayFone™. In some embodiments, the buyer device 104 may continuously update the localization service 25 with its current position (e.g., via a localization tracking functionality). In some embodiments, the positioning may be based on satellite-based radio navigation systems (e.g., the global positioning system (GPS), the Galileo positioning system, etc.) and/or a network of devices which positions are known (e.g., the radio beacon system). In some embodiments, the positioning may also be referred to as proximity detection. In some embodiments, the positioning may also come from the web browser which can access the self-localization service of the device. In some embodiments, the positioning may be deduced from the IP address used by the buyer device to load the web page. Multiple variations as to how the localization/positioning/proximity detection may be implemented may be envisioned without departing from the scope of the present technology. In some embodiments, the coordinates of the buyer device may be retrieved from the link the buyer is sent to from the text message. In another, the coordinates may be transmitted in accordance with an app on the buyer phone (whether a dedicated downloaded app or part of the operating system app (e.g. google OS) or part of another app that is using GPS permissions for other things (e.g. google maps) and will communicate coordinates upon request. If the buyer device 104 location and seller device 102 location are in proximity, the server 20 will deduct that the buyer 4 is indeed standing in front of the seller 2 and/or physically present in the store of the seller 2. At that point, the server 20 may conclude that the buyer 4 is proximal to the seller 2 without further communication between the seller device 102 and buyer device 104. For example because the buyer device 104 is confirmed to be proximal to the seller device 102, a text message might not be sent to the buyer device 104 for the buyer 4 to confirm that the buyer 4 intends to perform this transaction. This may reduce the need for buyer 4 to access his phone (buyer device 104) and take action to approve the transaction.

The verification & authentication service 26 may receive data about the transaction, the card being used, the merchant information and the device of the cardholder to perform a risk assessment and decide to authenticate the cardholder without further verification, or to challenge the cardholder with additional verifications. As an example, the verification & authentication service 26 may be a 3DS service provider and may be embodied as Cardinal Commerce or NuData.

In some alternative embodiments, the ID verification service 22 may be operated by the server 20 which may communicate with one or more mobile operators and/or one or more device vendors of the buyer device 104 (e.g., Apple, Samsung, etc.) to obtain certain information. In some embodiments, the information may comprise a duration of how long the buyer device 104 has been held/associated with the buyer 4, location information, human behavior information that the one or more mobile operators may have collected about the buyer 4, mobile phone bill information and/or buying history (e.g., apps buying history). The information may be leveraged and/or compiled by the server 20 to add an additional level of security allowing confirming that the buyer 4 is the actual owner of the buyer device 104 and/or that the buyer 4 is the individual associated with the buyer device 104. Other alternatives may also be envisioned, such as alternative approaches leveraging biometric information about the buyer 4, analytics, social physics based on large amount of behavioral data combined with the use of machine learning algorithms to provide high accuracy and matching name and/or address with the mobile phone number or mobile phone ID. Specifically, the use of 3D Secure 1.0, 2.0 and later versions may be leveraged, despite being a Card Not Present system, to authenticate said buyer in this example of Card Present transaction. As such, once the buyer opens the link in the text, a browser opens which not only may produce an approve/decline request for the transaction, but also sends to the 3DS systems information about the phone per 3DS protocol. The browser may contain an SDK to collect phone info and compare to the card number. In addition, if the service, such as 3D Secure, requires additional authentication methods, such as personal ID questions, requesting that the buyer open a banking application on the phone etc., these can be asked directly from the open browser on the buyer's phone. In the case of a onetime password (OTP) requested by the service, the service will transmit the OTP to the buyer or otherwise communicate the OTP to the buyer, and the buyer will then enter the OTP on the seller device.

In some embodiments, the server 20 may call the verification & authentication service 26 directly, initiated by the originating device (for example the seller device 102) without providing the signature of the buyer device 104, instead it may or may not include the signature of the seller device 102, and it may or may not include a flag to indicate that the request is coming from the seller device 102. If the verification & authentication service 26 is based on a 3DS service, the issuer may or might not perform a risk-based assessment to decide whether or not to challenge the buyer 4 with a ‘step-up’. A step-up is used to verify and authenticate the buyer 4 with a second factor, it can consist of the issuer server 10 sending a message to the buyer device 104, such as but not limited to an SMS with One-Time-Password code to enter in the seller device 102, or a push notification asking the buyer 4 to open his bank app to authorize a transaction or operation after a PIN or biometric verification. Upon authentication, the transaction is processed for authorization. Although these steps are described as being performed by the issuer, they may be performed by other services and/or parties. The ‘issuer’ performing the risk-based assessment and/or step-up challenge may be the issuer of the ‘card’ or, if the issuer is not prepared for this type of step up, another service (such as a card Scheme (e.g. VISA)) may perform all or a portion of these actions.

In some embodiments, the server 20 may check if the transaction is consistent with the buyer's patterns in terms of location and type of expense (goods or services purchases, amount, etc.), by requesting the data from the issuer 6, payment card company 8, issuer server 10, and/or a third-party verification service that has access to aggregated data from issuers and merchants. If the location of the seller and/or the type of expense doesn't match the buyer's profile additional verifications might be required.

In some embodiments, the operator of the server 20 may manage a risk associated with the transaction and may therefore charge a higher transaction fee to the card association 8. The server 20 may determine the transaction fee based on a predicted level of risk for the transaction. The server 20 may manage the risk based on the information collected from the one or more mobile operators and/or the one or more device vendors of the buyer device 104. In some embodiments, the server 20 may also provide the card association 8 with data generated from the collected information so as to allow the card association 8 to arbitrate potential chargebacks.

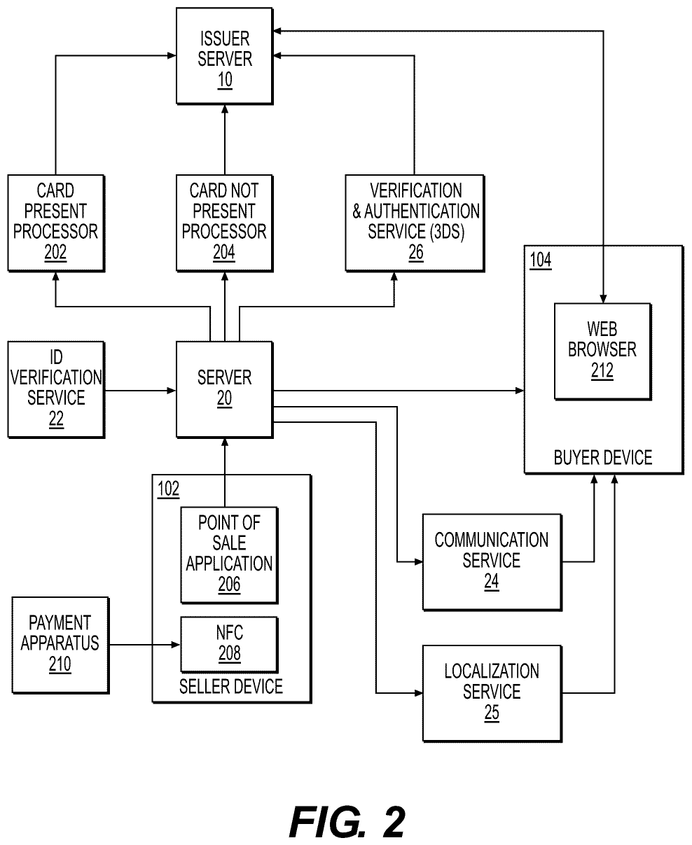

Turning now to FIG. 2, a high-level architecture of certain components of the environment shown in FIG. 1 is illustrated. The seller device 102, may be a mobile phone or a tablet (such as, but without being limitative a Galaxy™ from Samsung Inc., an iPhone™ or an iPad™ from Apple Inc.) operating a transaction receipt mechanism, such as, but without being limitative, a point of sale (POS) application 206 which allows the seller device 102 to operate as a payment terminal. The POS application 206 may allow the seller device 102 to operate as a payment terminal even though the seller device 102 is not a dedicated payment terminal. For example the POS application 206 may be based on the Bee™ technology from Mobeewave and/or any other suitable platform for a POS application. The POS application 206 may enable secured financial transactions by operating certain software modules on an isolated secured area of the processor and/or a secure element of the seller device 102.

The POS application 206 allows the seller device 102 to contactlessly acquire data from a payment apparatus 210, via a near field communication (NFC) interface 208. The payment apparatus 210 may be a contactless payment card or a device emulating a contactless payment card (e.g., a device operating Apple Pay™ or Samsung Pay™). The data acquired from the payment apparatus 210 may be a PAN and/or any other payment card data. Once acquired, the data may be securely transmitted to the server 20.

The server 20 may execute various steps in collaboration with the ID verification service 22, the communication service 24 and/or the buyer device 104 to securely complete a financial transaction between the seller 2 and the buyer 4. In some embodiments, the transaction may be a card present (CP) transaction executed by a CP transaction processor 202 or a card non-present (CnP) transaction executed by a CnP transaction processor 204. The CP processor 202 and/or the CnP processor 204 may be operated by the server 20 and/or the financial institution 11 and/or the payment card company 8.

The buyer device 104 may be used to authorize a transaction between the buyer 4 and the seller 2. In order to authorize a transaction the buyer device 104 may transmit a location of the buyer device 104 to the localization service 25. The location may be determined through a GPS or other positioning system in the buyer device 104. The location may be transmitted using the web browser 212. Similarly, the localization service 25 may acquire a position of the seller device. The location of the seller device 102 may be assumed to be a known physical location of the seller 2. The location of the buyer device 104 and the seller device 102 may be compared to determine whether the transaction should be authorized.

The buyer device 104 may transmit a signature, such as an audio signature and/or a signature emitted using a wireless protocol such as Bluetooth, NFC, or Wi-Fi. After a transaction has been initiated, the buyer device may receive a request to emit the signature, such as from the server 20. The buyer 4 may cause the buyer device 104 to emit the signature, such as by opening an application on the buyer device 104. The signature may be detected by the seller device 102. This may be an indication that the buyer device 104 is proximal to the seller device 102. Rather than causing the buyer device 104 to emit the signature, the buyer device 104 may emit the signature as part of normal operations. For example a MAC address, beacon, or other indication of the buyer device 104 may be detected by the seller device 102. The signature of the buyer device 104 may be captured by another device associated with the seller 2, such as a wireless access point.

If the buyer device 104 is determined not to be in proximity to the seller device 102, or if the location of either the buyer device 104 or the seller device 102 cannot be determined, a message may be sent to the buyer device 104 requesting that the buyer 4 authorize the transaction. A message may be sent to the buyer device 104, such as from the server 20, requesting that the buyer 4 authorize the transaction. The buyer 4 may use a web browser 212 to confirm or deny that they wish to authorize the transaction. The message may be sent as a text message to the buyer device 104. The buyer 4 may reply to the text message and/or open a web URL in the text message to authorize or deny the transaction.

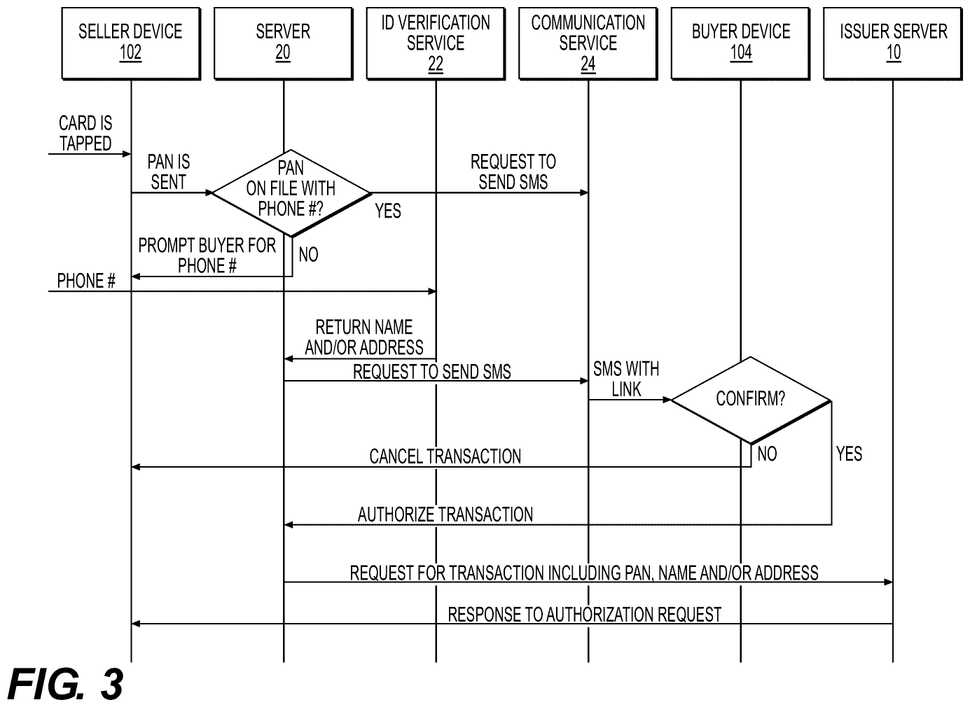

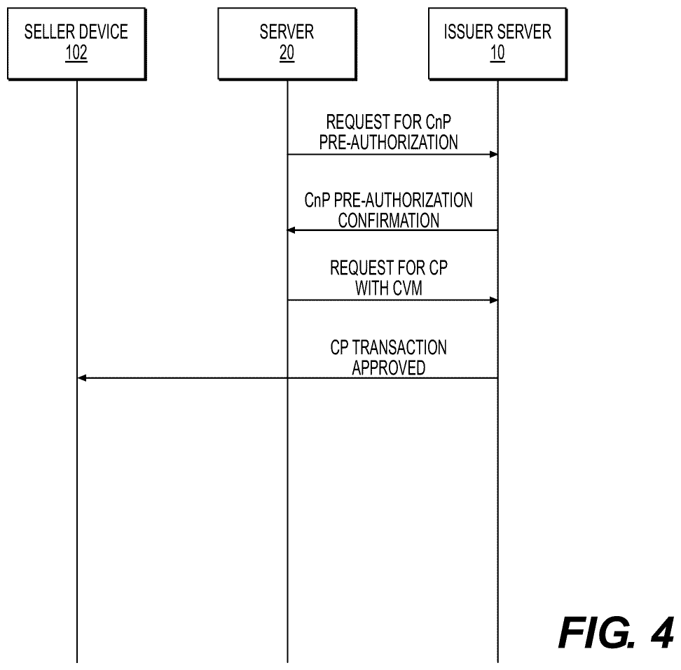

Turning now to FIGS. 3 and 4, flowchart representations of communication flows between several entities for conducting a secure contactless transaction is illustrated. In certain use cases and/or jurisdictions, contactless transactions exceeding a predetermined amount may require an additional authenticating step before a transaction may be processed. Any transactions, if card counter passes a certain count, or for other reasons may require an additional authenticating step before a transaction may be processed. Such additional authenticating step may be referred to as a cardholder verification method (CVM). As an example, a predetermined contactless transaction limit may be 100$ so that when an amount of a transaction exceeds 100$, a CVM action may need to be undertaken before a transaction may be processed (failure of completing the CVM action typically results in the transaction being declined). Under conventional approaches, the CVM action may require a physical interaction of the payment card with the terminal (reading of data located on a chipset of the payment card) and/or a personal identification number (PIN) to be entered by the cardholder (e.g., on the seller device 102). Such conventional CVM actions may be, at least in certain contexts, cumbersome and/or insecure. The present technology offers a less disruptive authenticating method, which may avoid the need to enter a PIN, while providing an additional security layer enabling contactless transaction even if a CVM request is triggered for any reason.

In accordance with the flowchart representation of FIG. 3, a POS application running on the seller device 102 enables a contactless reading of a payment apparatus (e.g., a payment card). The PAN is acquired by the seller device 102 (e.g., acquired by the secure element and/or TEE running on the processor of the seller device 102), encrypted and transmitted to the server 20. The server 20 queries a register, such as a database, to determine if the PAN is already associated with a buyer identifier such as a phone number. In some instances, the register may also comprise an identifier such as a cardholder name and/or a cardholder address of the individual associated with the PAN. If an association exists, then the server 20 transmits, to the communication service 24, a request to send an SMS message to the buyer device 104. Even though reference is made to a SMS message, this aspect is not limitative and other types of messages may be envisioned, such as notification messages. If no association exists (e.g., no phone number can be associated with the PAN), then the server 20 prompts, on the seller device 102, the buyer 4 to enter an identifier, such as her/his mobile phone number.

Once the identifier (e.g., mobile phone number) is received by the server 20, the server 20 queries the ID verification service 22 which looks up a name and/or address and/or another element associated to the provided identifier. If no match is found, then the server 20 undertakes to decline the transaction or take further action to verify the transaction. If a match is found, then the identifier, such as the name and/or address is transmitted to the server 20. In some embodiments, the server 20 may also supply additional data to the ID verification service 22, such as, but not limited to, location, type of seller (e.g., seller category code) and a transaction amount. In some embodiments, the ID verification service 22 uses that data to compute a trust score or equivalent that is sent back to the server 20 which can use it to decide to proceed with the transaction or decline it.

Once a phone number is identified (i.e., identified at the register of the server 20 or transmitted by the ID verification service 22), the server 20 may request a message, such as a SMS message or a notification message, be sent by the communication service 24 to the buyer device 104. The server 20 may also, concurrently, display on the seller device 102 that the message has been sent. Options may also be displayed on the seller device 102. The SMS message or notification message sent by the communication service 24 to the buyer device 104 may comprise a link to be clicked so as to confirm/authorize/complete the transaction. The SMS message or notification message may also comprise additional information such as the seller name, the amount of the transaction, the last four digits of the payment card, the date and time, a confirm transaction link/button and/or a decline link/button. Once received, the buyer 4 may confirm/authorize/complete or decline/refuse the transaction. In some embodiments, the buyer 4 may be required to unlock the buyer device 104 before completing the step of confirming/authorizing/completing or declining/refusing the transaction. The unlocking may be completed via code, pattern, face recognition and/or fingerprint thereby allowing confirmation that the buyer 4 is properly associated with the buyer device 104. This step results in a reinforced security level associated with the transaction.

When the buyer 4 responds to the message, the verification and authentication service 26 may authenticate the buyer 4. A signature of the buyer device 104 may be sent to the verification and authentication service 26. The signature may include information describing the buyer device 104, such as a manufacturer, operating system, time zone, web browser, etc. of the buyer device 104. Any information describing the device 104 may be sent to the verification and authentication service 26. The verification and authentication service 26 may compare the received information to previously recorded information relating to the buyer 4. If the information matches, the verification and authentication service may authenticate the buyer 4 and allow the transaction to proceed. Otherwise, the verification and authentication service 26 and/or any other system such as the issuer server 10 may request that the buyer 4 perform an action in order to authenticate themselves. The buyer device 104 may be sent a message requesting that the buyer 4 activate an application on the buyer device 104, such as a banking application, and confirm that the buyer 4 wishes to authorize the transaction. The verification and authentication service 26 may send the buyer 4 a message with a one-time password (OTP) that the buyer 4 may enter into the seller device 102. After receiving confirmation that the correct OTP has been input to the seller device 102, the verification and authentication service 26 may authenticate the buyer 4 and allow the transaction to proceed. If the verification and authentication service 26 does not authenticate the buyer 4, the transaction may be canceled. It should be understood that any other system may perform some or all of the steps for authentication. For example the issuer server 10 may send the OTP or other authentication request to the buyer device 104.

In some embodiments, an application on the buyer device 104 and/or part of the operation system (OS) on the buyer device 104, can read the message sent (e.g. notification, SMS), decipher it, and take action on it, rather than have the buyer access the message directly. In addition, the message may be directed directly to an application or the OS on the device, triggering an action. It may also be that no buyer intervention is needed if the application or OS already has identified the buyer and can respond in its stead.

If the buyer 4 declines/refuses the transaction, the server 20 cancels the transaction and transmits a cancelation message to the seller device 102. If the buyer 4 confirms/authorizes/completes the transaction, then the server 20 undertakes to send a request for authorizing the transaction to the issuer server 10. The request comprises the PAN and any other information the tap or enter of the card requests. This may include zip or card verification value (CVV) or another info, similar to a card not present transaction. Alternatively, a third party may take liability to the transaction being fraudulent and ask the issuer to approve. The issuer server may process the request and determine whether the transaction is to be authorized. A response is then transmitted to the remote server 20 and/or the seller device 102.

The request sent to the issuer server 10 may be deemed to be a card not present (CnP) request as it comprises data (i.e., PAN, cardholder name and/or address) required to complete such CnP transaction. Part of such data (i.e., PAN, cardholder name and/or address) is typically not available from a contactless reading of a payment card as the reading is usually limited to extracting the PAN. In addition, as the transaction is processed as a CnP transaction, it is not subjected to the threshold limit set forth in certain instances for contactless transaction. In some embodiments, it is assumed the issuer server 10 will only authorize the CnP transaction if the PAN is matching the supplied cardholder name and/or address and will otherwise decline the transaction.

Turning now to FIG. 4, the flowchart illustrates an alternative sequence of steps which may be executed between the server 20 and the issuer server 10 to authorize the transaction. In this alternative embodiment, a request comprising the PAN and the cardholder name is sent to the issuer server 10 with a low amount (below the established threshold limit for contactless transactions). The request is sent as a CnP pre-authorization request. The issuer server 10 may return a pre-authorization confirmation which may be voided by the server 20. The server 20 may then transmit a CP request comprising a CVM flag. The server 20 may undertake to transmit the CVM as the transaction has been previously verified via the SMS message or notification message sent to the buyer device 104. The issuer server 10 may then receive the CP request and return a transaction approval or transaction refusal, as the case may be.

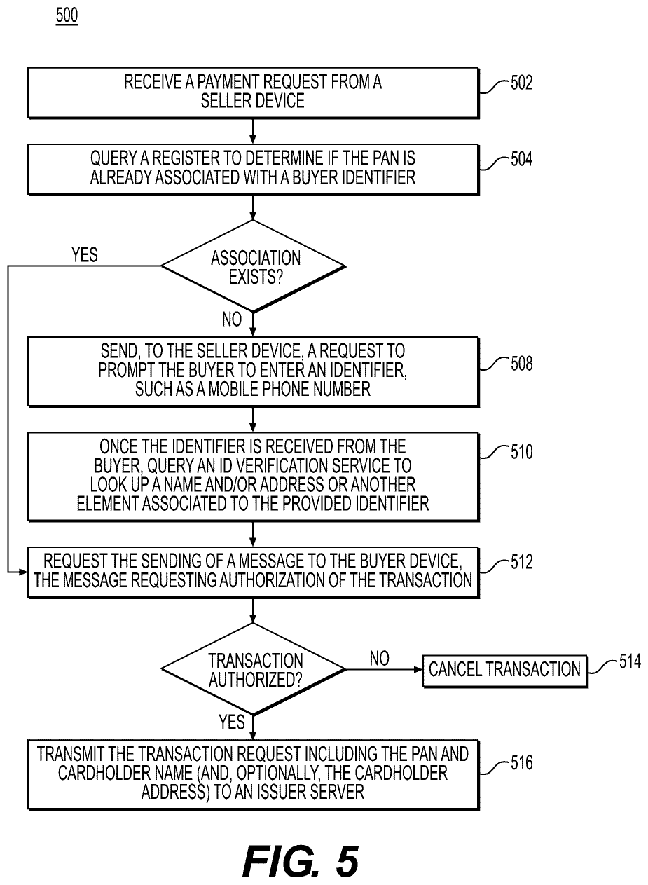

Having described, with reference to FIGS. 1 to 4, some non-limiting example instances of systems and computer-implemented methods used in connection with conducting a secure contactless transaction, we shall now describe a general solution with reference to FIG. 5.

More specifically, FIG. 5 shows a flowchart illustrating a computer-implemented method 500 implementing embodiments of the present technology. The computer-implemented method of FIG. 5 may comprise a computer-implemented method executable by a processor of the seller device 102, the buyer device 104 and/or the server 20 and/or one or more servers, the method comprising a series of steps to be carried out by the seller device 102, the buyer device 104 and/or the server 20 and/or one or more servers.

The computer-implemented method of FIG. 5 may be carried out, for example, by a processor executing program instructions having been loaded, for example, into random access memories and/or a secure element.

The method 500 starts at step 502 by receiving a payment request from the seller device 102. The payment request comprises a PAN. The payment request may comprise an amount, an indicator of the seller such as a merchant identifier, and/or any other information regarding the transaction.

At step 504, the method 500 queries a register to determine if the PAN is already associated with a buyer identifier, such as a mobile phone number. For example if the buyer has previously entered their phone number during a transaction, the phone number of the buyer may have been stored in association with the PAN. If an association exists, the method proceeds to step 512 by requesting the sending of a message to a buyer device 104, the message requesting authorization of the transaction. If no association exists, the method proceeds to step 508 by sending, to the seller device 102, a request to prompt the buyer to enter an identifier, such as a mobile phone number. At step 510, once the identifier is received from the buyer, an ID verification service is queried to look up a name and/or address or another element associated to the provided identifier. If no match is found, then the server 20 undertakes to decline the transaction at step 514. If a match is found, then the identifier, such as the name and/or address is transmitted to the server 20.

At step 512, a message is sent to the buyer device 104 to request authorization of the transaction. Once the authorization is received from the buyer device 104, the server 20 transmits, at step 516, the transaction request including the PAN and cardholder name (and, optionally, the cardholder address) to the issuer server 6 which processes the transaction request. Although the transaction request is described here as being sent to the issuer server 10, it should be understood that the transaction request may be sent to various other entities and/or servers. For example the transaction request may be sent to the seller, an acquirer, a processor, etc. The transaction request may first be sent to another entity and then be forwarded to the issuer server 10.

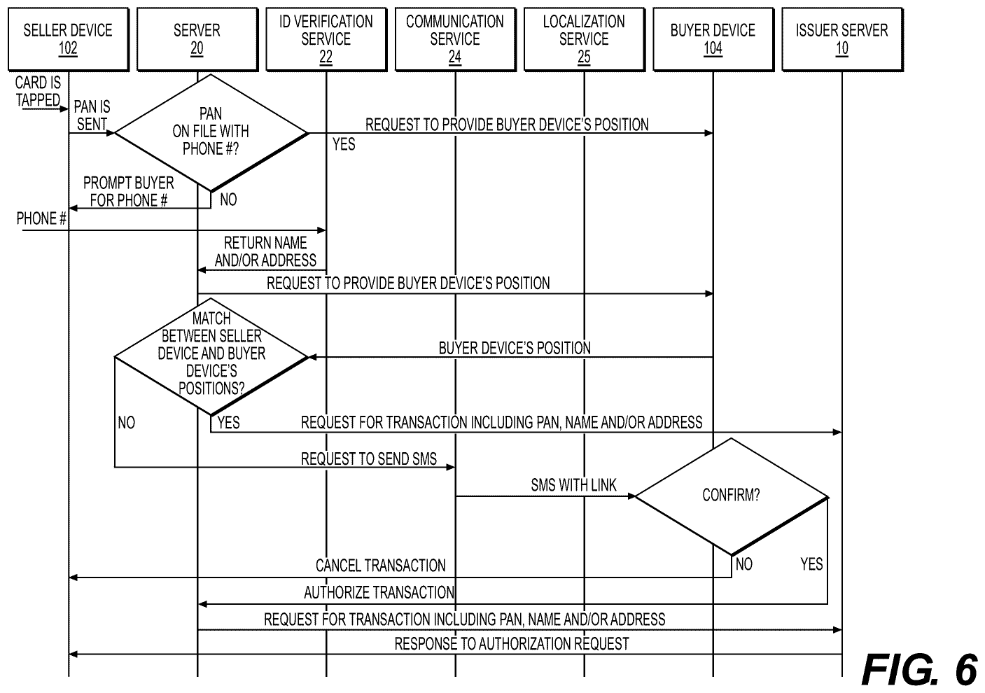

Turning now to FIG. 6, a flowchart representation of communication flows between several entities for conducting a secure contactless transaction according to a first alternative embodiment is illustrated.

In this first alternative embodiment, once the PAN is received by the server 20 from the seller device 102, the server 20 queries a register to determine if the PAN is already associated with a buyer identifier. If an association exists, then the server 20 requests a position of the buyer device 104. If no association exists, then the server 20 prompts, on the seller device 102, the buyer 4 to enter an identifier, such as her/his mobile phone number. Once the identifier is obtained, the server 20 may then request a position of the buyer device 104.

In some embodiments, the request to obtain the position of the buyer device 104 may be sent by the seller device 102 or by the server 20 to the buyer device 104 or to the localization service 25. The sending of the request may be based on the buyer identifier associated with the PAN (e.g., a mobile phone number). In alternative embodiments, the request may comprise the buyer identifier (e.g., in implementations wherein the request is sent to the localization service 25). In return, the server 20 receives from the buyer device 104 and/or from the seller device 102 and/or from the localization service 25 a position (e.g., coordinates) of the buyer device 104. The position of the buyer device may be an exact position, such as a set of coordinates, or may be defined as an area.

In some embodiments, the position of the seller device 102 may be known in advance by the server 20, such as a known physical location of the seller 2. In some other embodiments, the position of the seller device 102 may be received by the server 20 from the seller device 102 (e.g., upon conducting the transaction) and/or from the localization service 25.

Once the position of the buyer device 104 and the position of the seller device 102 are known, the server 20 may determine whether a position of the buyer device 104 and a position of the seller device 102 match so as to establish whether the buyer is actually located within a vicinity of the seller device 102. The server 20 may determine whether the buyer device 104 is within a pre-determined threshold distance of the seller device 102. This comparison step executed by the server 20 may be qualified an authentication step.

The server 20 may determine how close the buyer device 104 and the seller device 102 are from one another. If a distance between the buyer device 104 and the seller device 102 is below a given threshold (e.g., a threshold establishing an acceptable proximity given the context of the completion of a financial transaction), then it may establish that the buyer is standing close to the seller device and that she/he is the one who tapped the card on the seller device 102. In such instances, the server 20 may undertake to send a request for authorizing the transaction to the issuer server 10 in accordance with the sequence of steps previously described in connection with FIG. 3-5.

If a distance between the buyer device 104 and the seller device 102 is above the given threshold, then it may be established that the buyer is not standing close to the seller device and/or that she/he is not the one who tapped the card on the seller device 102. In some embodiments, under such circumstances, the transaction may be cancelled. In alternative embodiments, under such circumstances, the server may proceed to an alternative authentication step. As an example, the alternative authentication step may implement the requesting, by the server 20 of a message, such as a SMS message or a notification message, to be sent by the communication service 24 to the buyer device 104. Once received, the buyer 4 may confirm/authorize/complete or decline/refuse the transaction in accordance with the sequence of steps previously described in connection with FIG. 3-5. If the buyer is requested to respond to the notification message, the verification and authentication service 26 may be called to authenticate the buyer 4. The buyer 4 may be requested to verify the transaction using an application on the buyer device 104 and/or the buyer 4 may be provided an OTP to enter into the seller device 102. In some embodiments, the alternative authentication step may also be executed if the server 20 did not manage to obtain the position of the buyer device 104 and/or the position of the seller device 102. In yet some alternative embodiments, the alternative authentication step may also be executed even if determination has been made that the position of the buyer device 104 and the position of the seller device 102 match.

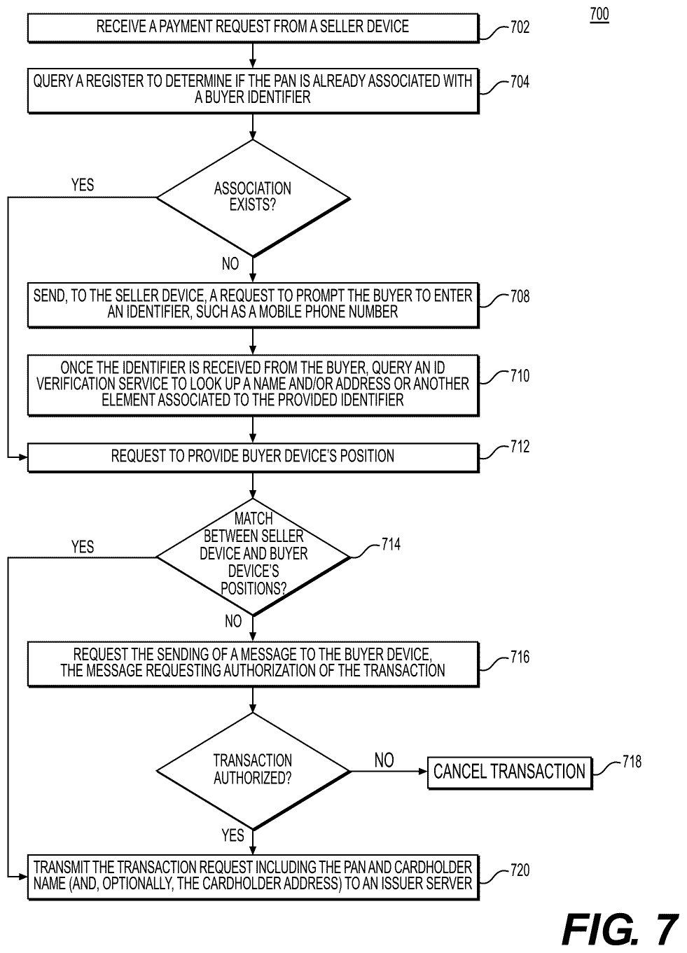

Turning now to FIG. 7, a flowchart illustrating a computer-implemented method 700 implementing steps of the embodiment of the first alternative embodiment of FIG. 6 is depicted. The method 700 comprises steps 702, 704, 708, 710 and 720 which are similar to the steps 502, 504, 508, 510 and 514 of the method 500.

At a step 712, the method 700 executes requesting to provide a position of the buyer device 104. As detailed in connection with the description of FIG. 6, the position of the buyer device 104 may be obtained from the buyer device 104 and/or from the seller device 102 and/or from the localization service 25.

At a step 714, the method 700 determines whether a position of the seller device 102 and a position of the buyer device 104 match. If the position of the buyer device 104 is within a threshold distance of the position of the seller device 102, the positions may be considered a match. If there is a match, then the method 700 proceeds to step 720 which is similar to the step 514 of the method 500. If (i) there is no match or if (ii) the acquisition of the position of the seller device 102 failed or if (iii) the acquisition of the position of the buyer device 104 failed, then the method 700 proceeds to steps 716 and 718 and/or 720 which are similar to the steps 512, 514, and/or 516 of the method 500.

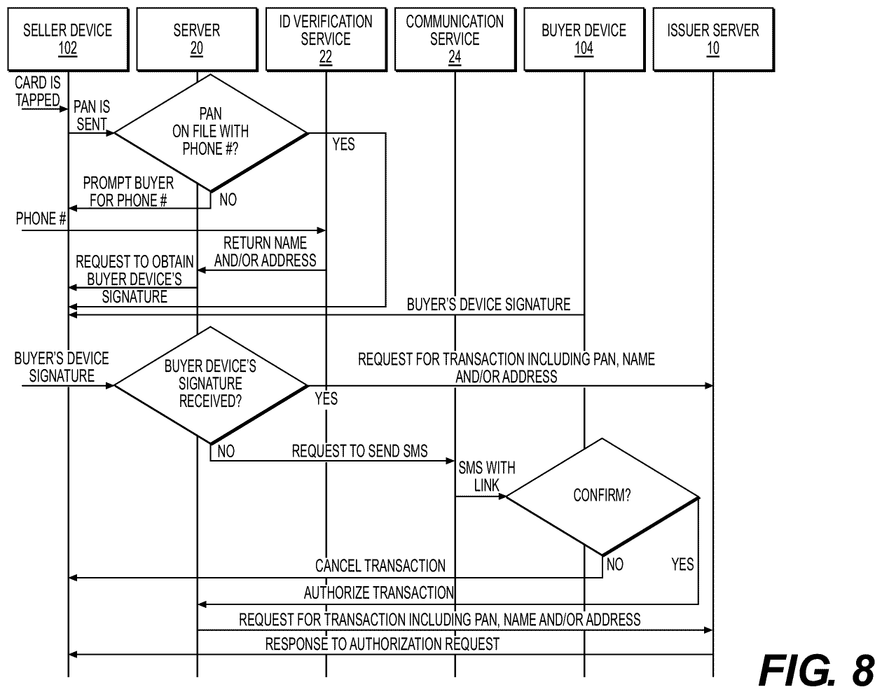

Turning now to FIG. 8, a flowchart representation of communication flows between several entities for conducting a secure contactless transaction according to a second alternative embodiment is illustrated.

This second alternative embodiment differs from the first alternative embodiment in that the server 20 requests to obtain a signature of the buyer device 104 instead of requesting to obtain a position of the buyer device 104. In some embodiments, the signature of the buyer device 104 may be implemented as a unique ID associated with the buyer device 104 (e.g., a MAC address, a beacon signature) and/or associated with the buyer (e.g., a mobile phone number). Multiple variations as to how the signature of the buyer device 104 may be implemented are envisioned without departing from the scope of the present technology. All or a portion of the signature may be used by the verification and authentication service 26 to authenticate the buyer device 104.

The signature of the buyer device 104 may be detected by the seller device 102 when the buyer device 104 is in a vicinity of the seller device 102. In some embodiments, the signature of the buyer device 104 may emanate from the buyer device 104 in accordance with one or more communication protocols (e.g., beacon, Bluetooth, Wi-Fi, etc.). In alternative embodiments, other devices communicating with the seller device 102 and/or the server 20 may operate the detection of the signature of the buyer device 104 (e.g., beacon devices located at a facility where the seller is located, etc.). Detection of the signature of the buyer device 104 may be operated continuously or solely upon authenticating a presence of the buyer during the process of completing a transaction. In some embodiments, detection of the signature of the buyer device 104 may be referred to as proximity detection. Once detection of the signature of buyer device 104 has occurred, the server 20 may determine that the buyer is actually located within a vicinity of the seller device 102. The server 20 may be informed of the detection of the buyer device 104 by the seller device 102 and/or other devices installed at a facility where the seller is located. In some embodiments, the seller 20 may receive one or more signatures from one or more devices and then need to establish whether one of the signatures corresponds to the signature of the buyer device 104. This determination may be conducted by the server 20 having acquired a signature of a device associated with the PAN and/or by the server 20 querying a service associating a unique buyer ID and signatures of devices associated with the buyer.

If the server 20 establishes that the signature of the buyer device 104 has been detected at a proper location (e.g., in a vicinity of the seller device 102 and/or at a facility where the seller is located) then it may establish that the buyer is standing close to the seller device and that she/he is the one who tapped the card on the seller device 102. In such instances, the server 20 may undertake to send a request for authorizing the transaction to the issuer server 10 in accordance with the sequence of steps previously described in connection with FIG. 3-5.

If the server 20 determines that the signature of the buyer device 104 has not been detected, then it may be established that the buyer is not standing close to the seller device 102 and/or that she/he is not the one who tapped the card on the seller device 102. In some embodiments, under such circumstances, the transaction may be cancelled. In alternative embodiments, under such circumstances, the server may proceed to an alternative authentication step as previously described in connection with FIG. 3-5. If the buyer is requested to respond to a notification message during the alternative authentication, the verification and authentication service 26 may be called to authenticate the buyer 4. The buyer 4 may be requested to verify the transaction using an application on the buyer device 104 and/or the buyer 4 may be provided an OTP to enter into the seller device 102.

In some alternative embodiments, the signature of the buyer device 104 is detected and recorded for every transaction. In some alternative embodiments, as payment is made, if the signature detected differs from the signature previously associated with the buyer device 104, the server 20 may suspect that the credit card may have been stolen and take actions. In some alternative embodiments, the server 20 may be able to establish dynamically when one or more signatures associated with the buyer are updated (e.g., when the buyer changes device, when new signatures are being generated, etc.).

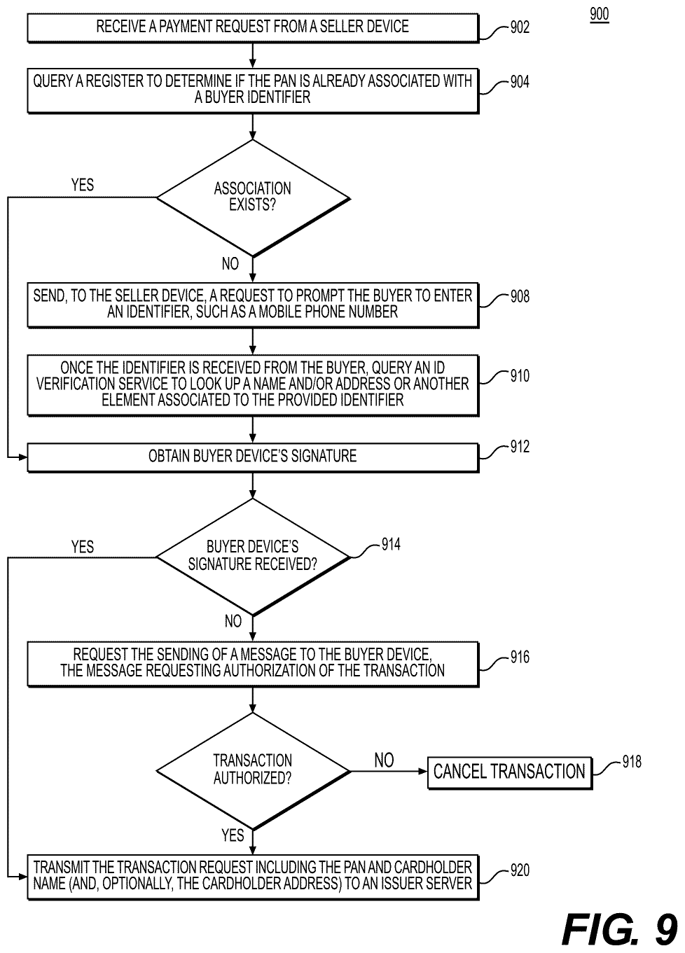

Turning now to FIG. 9, a flowchart illustrating a computer-implemented method 900 implementing steps of the embodiment of the second alternative embodiment of FIG. 8 is depicted. The method 900 comprises steps 902, 904, 908, 910 and 920 which are similar to the steps 502, 504, 508, 510 and 514 of the method 500.

At a step 912, the method 900 executes obtaining the signature of the buyer device 104. Then, at a step 914, the method 900 determines whether the signature of the buyer device 104 has been obtained and corresponds to the signature previously associated with the buyer device 104. If the signature of the buyer device 104 has been properly detected, then the method 900 proceeds to step 920 which is similar to the step 516 of the method 500. If the signature of the buyer device 104 has not been properly detected, then the method 900 proceeds to step 916 which is similar to the step 512 of the method 500.

In some alternative embodiments, the SMS message or notification message sent by the communication service 24 to the buyer device 104 may comprise a link to a secure web page where the cardholder is prompted for his payment card personal identification number (PIN), when submitted the PIN is encrypted by the web page, sent to the server 20, merged with the rest of the contactless transaction data then the transaction is submitted for authorization to the Card Present Processor 202. As an alternative the notification message can include or open an operative system (OS) level screen for the cardholder PIN to be entered. As an alternative the notification can ask the cardholder to use biometric (such as but not limited to fingerprint or facial recognition) to confirm the transaction, effectively removing the need for the PIN.

In order to authorize a transaction using the methods described herein the buyer 4 may receive a text message and open a web page. To perform these steps, the buyer 4 may use a phone plan with an enabled data plan. In the case of the buyer 4 traveling to a different country it is possible that no roaming service is provided by the mobile operator of the buyer. In that scenario the point of sale application 206 may provide instructions for how to find and activate an eSIM plan with data service on the buyer device 104, which can then be used to receive the text message and/or open a web page from a URL, such as a URL in the text message.

All of this risk management information collected during a transaction by the various embodiments described can be stored in the server 20 for a limited period of time as evidence that the buyer 4 was present and in proximity of the seller 2 during the transaction, so that if the buyer 4 decides to dispute the expense a party involved in the transaction, such as the seller 2 or financial institution 11 can step in and challenge the case in favor of the seller 2 to prevent chargebacks. For example any location data that was captured, signal data that was captured, or records indicating that the buyer 4 authorized the transaction may be stored.

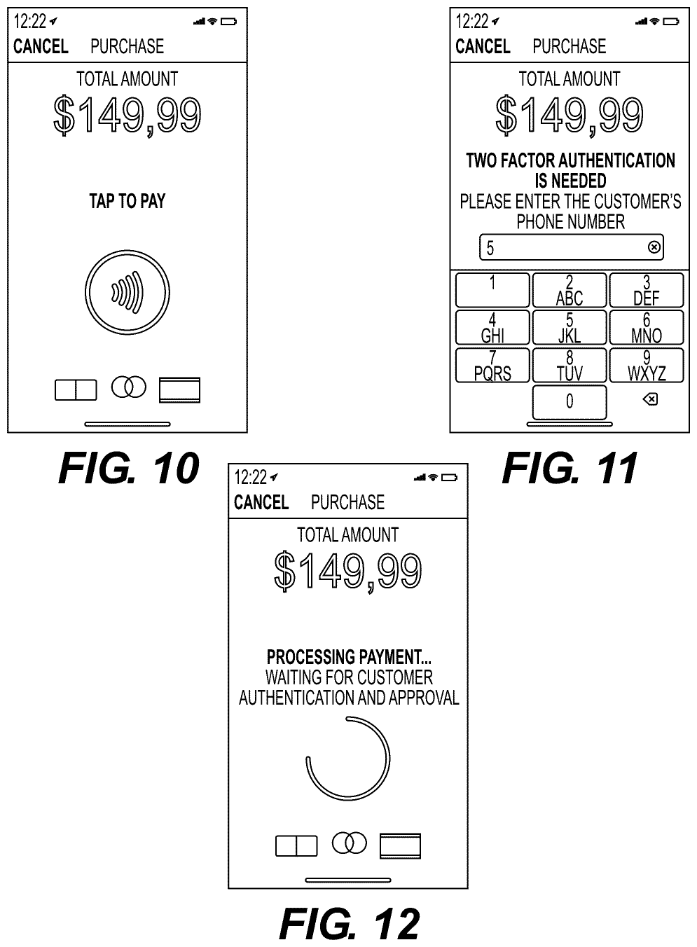

FIGS. 10-15 illustrate non-limitative exemplary embodiments of graphical user interfaces (GUIs) implementing certain steps of the methods 500, 700 and/or 900. It should be understood that the interfaces illustrated in FIGS. 10-15 are exemplary, and that any other suitable user interface may be used.

FIG. 10 illustrates an initial user interface that may be displayed by the seller device 102 to complete a transaction. The interface illustrated in FIG. 10 includes a transaction amount and an indication that the user should tap their payment card or buyer device 104 to perform the payment.

FIG. 11 illustrates an interface requesting an identifier of the buyer 4, such as the buyer's phone number. The interface illustrated in FIG. 11 may be displayed by the seller device 102. The seller 2 or buyer 4 may enter the buyer's phone number using the interface illustrated in FIG. 11. Although the illustrated interface requests a phone number, it should be understood that any other identifier may be requested and/or entered, such as an email address of the buyer 4.

FIG. 12 illustrates an interface that may be displayed by the seller device 102. The interface in FIG. 12 may be displayed while the transaction is being authorized. The interface in FIG. 12 may be displayed while receiving and comparing location data, receiving and comparing signal data, and/or waiting to receive authorization from the buyer 4. For example the interface in FIG. 12 may be displayed while a text message is being sent to the buyer device 104 and the buyer 4 is authorizing the transaction. After the buyer 4 has approved the transaction the interface illustrated in FIG. 12 may close and/or transition to another interface, such as an interface indicating that the transaction has been approved or denied.

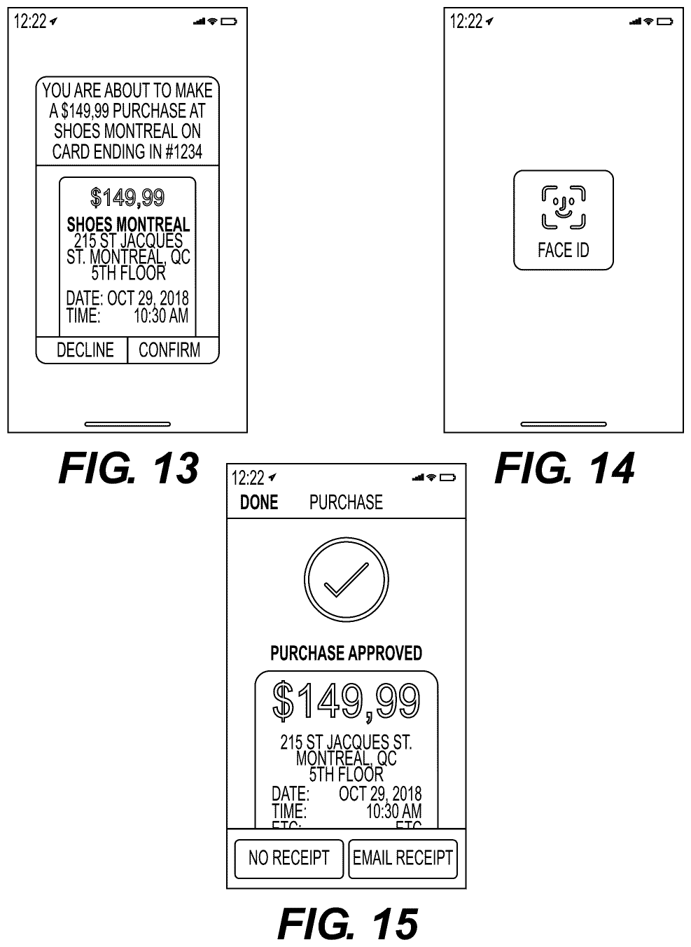

FIG. 13 illustrates on interface that may be displayed by the buyer device 104. The interface illustrated in FIG. 13 may allow the buyer to decline or confirm a transaction. The interface may include a transaction amount, an indication of the payment apparatus being used, an indication of the seller 2, a date, and/or a time. If the buyer 4 intends to complete the transaction, the buyer 4 may select the confirm button. On the other hand, if the buyer 4 is unaware of the transaction, such as if the buyer's payment card has been stolen, the buyer 4 may select the decline button.

FIG. 14 illustrates an interface that may be displayed to confirm that the buyer 4 wishes to authorize a transaction. The interface may be displayed by the buyer device 104. The interface illustrated in FIG. 14 may request that the buyer 4 provide biometric authentication, such as a scan of their face performed by the buyer device 104. After authenticating the buyer 4 the transaction may be authorized by the buyer 4.

FIG. 15 illustrates an interface that may be displayed by the seller device 102 and/or the buyer device 104. The interface illustrated in FIG. 15 may be displayed after the interface illustrated in FIG. 12, The interface illustrated in FIG. 15 may indicate that a transaction has been authorized. The interface provides the buyer 4 the option of receiving a receipt.

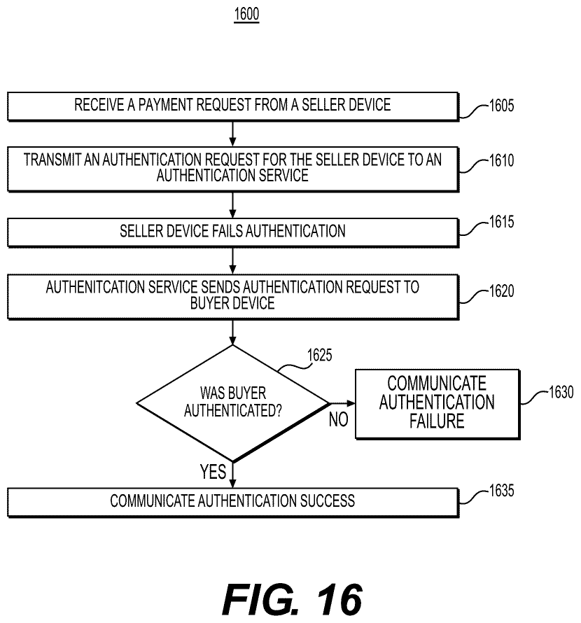

FIG. 16 shows a flowchart illustrating a computer-implemented method 1600 implementing embodiments of the present technology. The computer-implemented method of FIG. 16 may comprise a computer-implemented method executable by a processor of the seller device 102, the buyer device 104, the server 20, the verification and authentication service 26, and/or one or more other servers, the method comprising a series of steps to be carried out by the seller device 102, the buyer device 104, the server 20, the verification and authentication service 26, and/or one or more other servers.

The computer-implemented method of FIG. 16 may be carried out, for example, by a processor executing program instructions having been loaded, for example, into random access memories and/or a secure element.

At step 1605 a payment request may be received. The payment request may be received from the seller device 102. The payment request may comprise a PAN, payment card number, account number, name, date, transaction amount, and/or any other data relating to a transaction. The payment request may comprise a signature of the seller device 102. Actions performed at step 1605 may be similar to those performed at step 502 of the method 500.

At step 1610 an authentication request may be transmitted, such as to the verification and authentication service 26 and/or issuer server 10. The authentication request may include a device signature of the seller device 102. The device signature may include a type of the device, a manufacturer of the device, an indication of the operating system of the device, a time zone of the device, an indication of a web browser used by the device, which wireless protocols the device is actively using, and/or any other information describing the seller device 102. The authentication request may include any other information regarding the seller device 102.

At step 1615 the seller device 102 may fail the authentication. The verification and authentication service 26, issuer server 10, and/or any other system may determine that the seller device 102 has failed the authentication. After receiving the authentication request, the authentication service may retrieve a device signature associated with the buyer. The authentication service may use a PAN or other identifying information in the payment request to retrieve the device signature associated with the buyer. The authentication service may compare the device signature associated with the buyer to the received device signature. Because the received device signature corresponds to the seller's device, the authentication may fail. Because the authentication has failed, a second authentication may be used to verify the transaction.

At step 1620 an authentication request may be sent to the buyer's device. The authentication request may be sent by the verification and authentication service 26, issuer server 10, and/or any other system. Using the payment request, contact information for the buyer may be retrieved. The contact information may be used to transmit an authentication request to the buyer's device. Any suitable secondary form of authentication may be used. A one-time password (OTP) may be sent to the buyer's device. The buyer may be instructed to enter the OTP in the seller's device. A request to verify the transaction via an application may be transmitted to the buyer. For example a request to open a banking application and verify the transaction may be transmitted to the buyer.

At step 1625 a determination may be made as to whether the buyer was authenticated. If the buyer completed the secondary form of authentication at step 1620, the buyer may be considered to be authenticated. The method 1600 may then proceed to step 1635 to communicate that the authentication was successful. The verification and authentication service 26 may send a token indicating that the authentication was successful. Actions performed at step 1635 may be similar to those performed at step 516 of FIG. 5. If the buyer did not complete the secondary form of authentication, the authentication failure may be communicated at step 1630. The transaction may be cancelled if the authentication fails, or the transaction may proceed regardless of the authentication failure. Actions performed at step 1630 may be similar to those performed at step 514 of FIG. 5.

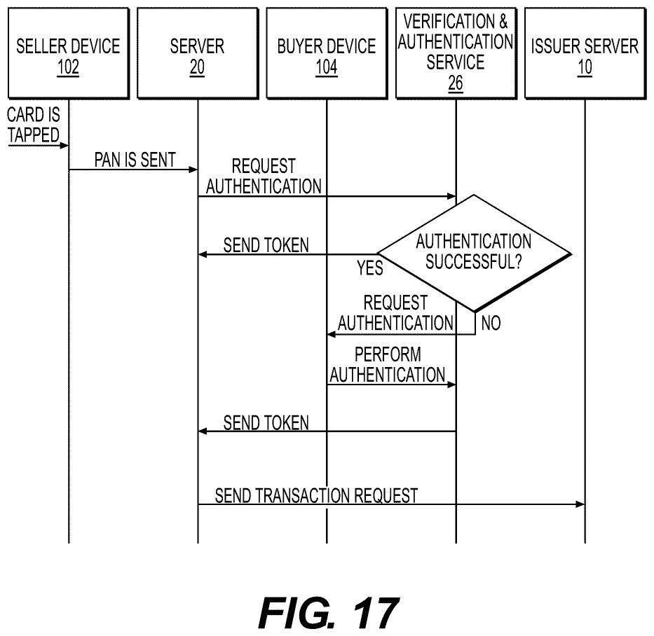

FIG. 17 is a flowchart representations of communication flows between several entities for conducting a secure contactless transaction. FIG. 17 illustrates a sequence of communications that may occur while performing the method 1600. A payment card or mobile device implementing a mobile wallet may be tapped to the seller device 102. The seller device 102 may receive information corresponding to the payment card, such as a PAN, card number, expiration date, name, address, token from a mobile wallet, etc. The seller device 102 may transmit all or a portion of the received data to the server 20. The seller device 102 may transmit additional data to the server 20, such as a transaction amount, merchant information, etc.

The information received by the seller device 102 may indicate that additional authentication should be performed. The server 20 may send a request to the verification and authentication service 26 to authenticate the transaction. The request may be a request for a token indicating that the transaction has been authenticated. The request sent from the server 20 to the verification and authentication service 26 may include all or a portion of the data received by the server 20 from the seller device 102.

The verification and authentication service 26 may authenticate the transaction based on the data received from the server 20. If the authentication is successful, the verification and authentication service 26 may send a token to the server 20. The token may indicate that the transaction was authorized.

If the verification and authentication service 26 was not able to authenticate the transaction based on the data sent from the seller device 102, the verification and authentication service 26 may send an authentication request to the buyer device 104. The authentication request may be a request for the buyer to authorize the transaction using an application on the buyer device 104, such as a banking application. The verification and authentication service 26 may send an OTP to the buyer device 104. The buyer may enter the OTP into the seller device 102. The seller device 102 may then send the OTP to the verification and authentication service 26. Although FIG. 17 illustrates that the verification & authentication service 26 sends the authentication request to the buyer device 104, it should be understood that any other system may send the authentication request, such as the issuer server 10.

After the verification and authentication service 26 has authenticated the buyer, the verification and authentication service 26 may send a token to the server 20. The token may indicate that the buyer was authenticated.

The server 20 may send a transaction request to the issuer server 10. The transaction request may include the token. If authentication failed and a token was not received, the server 20 may still send the transaction request to the issuer server 10, but without any token. The transaction request may include data received from the seller device 102 such as a PAN, a token, a transaction amount, and/or any other data relating to the transaction. The issuer server 10 may determine whether to approve or decline the transaction. Although the transaction request is described here as being sent to the issuer server 10, it should be understood that the transaction request may be sent to various other entities and/or servers. For example the transaction request may be sent to the seller, an acquirer, a processor, etc. The transaction request may be forwarded to the issuer server 10.

Notably, the features and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific embodiments so fully reveals the general nature of the disclosure that others can, by applying knowledge within the skill of the relevant art(s) (including the contents of the documents cited and incorporated by reference herein), readily modify and/or adapt for various applications such specific embodiments, without undue experimentation and without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While the above-described implementations have been described and shown with reference to particular steps performed in a particular order, it will be understood that these steps may be combined, sub-divided, or re-ordered without departing from the teachings of the present technology. The steps may be executed in parallel or in series. Accordingly, the order and grouping of the steps is not a limitation of the present technology.

While various embodiments of the present disclosure have been described above, it should be understood that they have been presented by way of example, and not limitations. It would be apparent to one skilled in the relevant art(s) that various changes in form and detail could be made therein without departing from the spirit and scope of the disclosure. Thus, the present disclosure should not be limited by any of the above-described exemplary embodiments, but should be defined only in accordance with the following claims and their equivalents.

What is claimed is:

1. A method, comprising:
receiving, by a first device, a payment request from a second device;
querying, by the first device, a register to determine if an account number in the payment request is associated with an identifier associated with the first device;
determining whether the association between the account number and the identifier exists;
in accordance with a determination that the association exists, requesting, by the first device, to provide a position of the first device;
determining, by the first device, whether a first position of the first device matches a second position of the second device; and
in accordance with a determination that the first position of the first device matches the second position of the second device, generating, by the first device, a transaction request for a transaction configured to be transmitted to an issuer server device.

2. The method of claim 1, wherein determining whether the first position of the first device matches the second position of the second device comprises determining, by the first device, whether the first position is within a threshold distance of the second position of the second device.

3. The method of claim 1, further comprising:
in accordance with a determination that the association does not exist:
sending, to the second device, a request to prompt the first device to enter an identifier; and
querying an identifier verification service to look up a name and/or address associated with the identifier.

4. The method of claim 3, wherein the identifier comprises a mobile phone number of the first device.

5. The method of claim 1, further comprising:
in accordance with a determination that the first position of the first device does not match the second position of the second device, requesting, by the first device, a sending of a message to the first device that requests authorization of the transaction.

6. The method of claim 5, further comprising:
determining whether the transaction is authorized based at least in part on a response to the message.

7. The method of claim 6, further comprising:
in accordance with a determination that the transaction is authorized, transmitting, by the buyer device, the transaction request for the transaction to the issuer server device; and
in accordance with a determination that the transaction is not authorized, canceling the transaction.

8. The method of claim 1, wherein the first device comprises a buyer device and wherein the second device comprises a seller device.

9. The method of claim 8, wherein the payment request comprises at least one of an amount, an indicator of the seller device, or other information regarding the transaction.

10. The method of claim 1, wherein the indicator of the seller device comprises a merchant identifier.

11. The method of claim 1, wherein the account number in the payment request comprises a primary account number.

12. The method of claim 1, wherein the position of the first device is obtained from the first device, the second device, or a localization service.

13. One or more non-transitory computer-readable medium, storing computer-executable instructions that, when executed by one or more processors of a first device, configure the one or more processor to perform operations comprising:
receiving, by the first device, a payment request from a second device;
querying, by the first device, a register to determine if an account number in the payment request is associated with an identifier associated with the first device;
determining whether the association between the account number and the identifier exists;
in accordance with a determination that the association exists, requesting, by the first device, to provide a position of the first device;
determining, by the first device, whether a first position of the first device matches a second position of the second device; and
in accordance with a determination that the first position of the first device matches the second position of the second device, generating, by the first device, a transaction request for a transaction configured to be transmitted to an issuer server device.

14. The one or more non-transitory computer-readable medium of claim 13, wherein determining whether the first position of the first device matches the second position of the second device comprises determining, by the first device, whether the first position is within a threshold distance of the second position of the second device.

15. The one or more non-transitory computer-readable medium of claim 13, wherein the operations further comprise:
in accordance with a determination that the association does not exist:
sending, to the second device, a request to prompt the first device to enter an identifier; and
querying an identifier verification service to look up a name and/or address associated with the identifier.

16. The one or more non-transitory computer-readable medium of claim 15, wherein the identifier comprises a mobile phone number of the first device.

17. The one or more non-transitory computer-readable medium of claim 13, wherein the operations further comprise:
in accordance with a determination that the first position of the first device does not match the second position of the second device, requesting, by the first device, a sending of a message to the first device that requests authorization of the transaction.

18. A first device, comprising:
one or more memories configured to store computer-executable instructions; and
one or more processors connected to the one or more memories and configured to execute the computer-executable instructions to at least:
receive, by the first device a payment request from a second device;
query, by the first device, a register to determine if an account number in the payment request is associated with an identifier associated with the first device;
determine whether the association between the account number and the identifier exists;
in accordance with a determination that the association exists, request, by the first device, to provide a position of the first device;
determine, by the first device, whether a first position of the first device matches a second position of the second device; and
in accordance with a determination that the first position of the first device matches the second position of the second device, generate, by the first device, a transaction request for a transaction configured to be transmitted to an issuer server device.

19. The first device of claim 18, wherein determining whether the first position of the first device matches the second position of the second device comprises determining, by the first device, whether the first position is within a threshold distance of the second position of the second device.

20. The first device of claim 18, wherein the one or more processors are further configured to execute the computer-executable instructions to at least:
in accordance with a determination that the association does not exist:
send, to the second device, a request to prompt the first device to enter an identifier; and
query an identifier verification service to look up a name and/or address associated with the identifier.
